(19) United States
(12) Patent Application Publication
(10) Pub. No.: US 2018/0125622 A1
(43) Pub. Date: May 10, 2018

(54) DENTAL TOOLS WITH REMOVABLE INSTRUMENT HEADS AND FLUID DELIVERY LINES

(71) Applicant: University of Dammam, Dammam (SA)

(72) Inventor: Saud Abdullah A. ALMOUMEN, Dammam (SA)

(73) Assignee: University of Dammam, Dammam (SA)

(21) Appl. No.: 15/347,398

(22) Filed: Nov. 9, 2016

(51) Int. Cl. A61C 17/02; A61C 17/20; A61C 1/00; A61C 1/14; A61C 1/07; A61C 3/03; A61C 17/00

(52) U.S. Cl. CPC A61C 17/0202; A61C 17/20; A61C 1/0069; A61C 1/0092; A61C 17/005; A61C 1/14; A61C 1/07; A61C 3/03; A61C 1/0023

(57) ABSTRACT

A dental instrument comprising a handle removably attached to an instrument head. The handle has at least two fluid lines in fluid communication with at least one aperture in the instrument head, and may be used for aspiration and irrigation. Details of fluid line and aperture arrangements are discussed, as well as instrument heads and attachment mechanisms.

### BACKGROUND OF THE INVENTION

### Technical Field

The present invention relates to a dental instrument comprising a handle with at least two fluid-carrying lines and a removable instrument head with at least one aperture.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In the course of oral surgery or dental cleaning procedures, hygienists, dentists, and oral surgeons must manipulate a variety of tools within the confined space of a patient's mouth. These procedures tend to require periodic rinses with an irrigating fluid, such as water, and frequent aspiration of the irrigated fluid and/or excess saliva of the patient. This may be done with two specialized tools: a common air/water syringe, and a saliva ejector or a surgical aspirator. Some procedures may require irrigation with fluids other than water, for example, some root canal procedures precisely irrigate with a small volume of sodium hypochlorite. Thus, it can be tedious for a dental practitioner or surgeon to frequently exchange the tools in a patient's mouth in order to irrigate or aspirate in the middle of a procedure, or to irrigate with different fluids.

Instruments that combine irrigation and/or aspiration with a dental or surgical function have been described previously. For example, tissue debriders have been designed to incorporate irrigation and/or aspiration, however, these tools do not have replaceable heads and thus lack a variety of functionality. Thus, in a moment when this type of tissue debrider is not being used, the surgeon must resort to traditional air/water syringes and surgical aspirators, or use additional surgical tools that similarly combine irrigation and aspiration capabilities. However, the latter option requires each tool to have individual tubing assemblies connected to pumps, and the arrangement becomes unnecessarily complicated to manage, especially in the middle of a procedure.

A few dental and surgical tools with combined irrigation and/or aspiration capabilities have been designed with instrument heads removably attached to instrument handles. However, different types of instrument heads are not designed to be exchanged with a single instrument handle, thus leading to the same lack of versatility as discussed previously with the tissue debriders.

In other cases, instruments that combine irrigation and/or aspiration with replaceable instrument heads have been described to have the irrigation and/or aspiration lines located outside or adjacent to the functional instrument head. However, this arrangement of exterior tubing causes the instrument to become unnecessarily large and unwieldy, which can make it difficult or impossible to use in a small site such as a root canal cavity. To overcome the bulkiness of the instrument, the opening to the irrigation or aspiration tubing might be spaced from the functional part of the instrument head (for example, 5-10 mm, or more from the cutting edge of a scalpel blade). However, this spacing decreases the accuracy of precisely irrigating or aspirating at the functional part of the instrument.

In some cases, instruments that combine irrigation and/or aspiration with replaceable instrument heads have handles with only one fluid line. While a pump assembly connected to this type of handle by tubing may be configured to switch between more than one type of fluid, or between a fluid and aspiration, a delay would be experienced at the instrument head while waiting for the handle and the length of tubing to exchange its volume. In addition, this exchange between irrigation liquids or from aspiration to irrigation creates excess irrigant or air being emitted at the instrument head, which may harm the patient. Switching a length of tubing from aspiration to irrigation also introduces contamination issues. Thus, these single fluid line instruments cannot easily be used for a combination of irrigation liquids or for switching between irrigation and aspiration.

In view of the forgoing, one objective of the present invention is to provide a dental instrument comprising a handle with at least two fluid-carrying lines and a removable instrument head with at least one aperture.

### BRIEF SUMMARY OF THE INVENTION

According to a first aspect, the present disclosure relates to a dental instrument that has an elongated handle with a hose end and a head end with at least one first handle fluid line disposed in and traversing the handle from the hose end to the head end and at least one second handle fluid line disposed in the handle and connected to the hose end. The dental instrument has an instrument head with a connection end and at least one first aperture at a distal end, wherein the connection end is removably attached to the head end of the handle. Within the instrument head is at least one first head fluid line traversing the instrument head from the connection end to the at least one first aperture. The first handle fluid line is in fluid communication with the first head fluid line, and the instrument head comprises a blade, a spike, a spatula, a hook, a fork, a bead, or any combination thereof.

In one embodiment, the instrument head of the dental instrument has at least two first apertures in fluid communication with at least one first head fluid line.

In one embodiment, the instrument head of at least one first aperture is elongated.

In one embodiment, the connection end of the instrument head is removably attached to the head end of the handle by a screw thread connection.

In one embodiment, the dental instrument has an unthreaded joint assembly between the handle and the instrument head.

In one embodiment, the instrument head is a fork with a plurality of prongs, with the first aperture disposed at the end of each prong and in fluid communication with the at least one first head fluid line.

In one embodiment, the dental instrument has a slidable plunger within the at least one first handle fluid line.

In one embodiment, a plane enclosed by an edge of at least one first aperture is substantially perpendicular to an adjacent surface of the instrument head.

In one embodiment, the dental instrument has an ultrasonic transducer.

In one embodiment, the dental instrument has a joint in a middle portion of the first handle fluid line, wherein the second handle fluid line connects to and is in fluid communication with the first handle fluid line via the joint.

In a further embodiment, this joint comprises a valve.

In a further embodiment, the dental instrument has at least one button or at least one switch on an exterior surface of the handle to control the valve.

In one embodiment, the dental instrument has at least one second head fluid line disposed in and traversing the instrument head from the connection end to at least one second aperture at the distal end, where the second handle fluid line traverses the handle from the hose end to the head end and is in fluid communication with the second head fluid line.

In a further embodiment, a plane enclosed by an edge of the at least one first aperture is substantially parallel to a second plane enclosed by a second edge of the at least one second aperture and the first and second apertures face each other.

In a further embodiment, the first handle fluid line and the second handle fluid line are arranged coaxially.

In a further embodiment, the instrument head is rotatably connected to the handle, so that rotating the instrument head circumferentially relative to a longitudinal axis of the handle in a first position forms the fluid connection between the first handle fluid line and the first head fluid line and the fluid connection between the second handle fluid line and the second head fluid line, and rotating the instrument head circumferentially relative to the longitudinal axis of the handle in a second position disconnects the first handle fluid line from the first head fluid line and the second head fluid line from the second handle fluid line.

According to a second aspect, the present disclosure relates to a dental instrument assembly comprising a dental instrument and a pumping module. The dental instrument has an elongated handle with a hose end and a head end with at least one first handle fluid line disposed in and traversing the handle from the hose end to the head end and at least one second handle fluid line disposed in the handle and connected to the hose end. The dental instrument has an instrument head with a connection end and at least one first aperture at a distal end, wherein the connection end is removably attached to the head end of the handle. Within the instrument head is at least one first head fluid line traversing the instrument head from the connection end to the at least one first aperture. The first handle fluid line is in fluid communication with the first head fluid line, and the instrument head includes, or is in the form of, a blade, a spike, a spatula, a hook, a fork, a bead, or any combination thereof. The pumping module is fluidly connected to the handle's hose end by a hose to deliver a fluid to the instrument head and carry an aspirate from the instrument head.

In a further embodiment of the dental instrument assembly, the pumping module comprises a temperature regulator.

In a further embodiment, the dental instrument assembly has a foot pedal electrically connected to and controlling the pumping module.

In a further embodiment, the dental instrument assembly has a foot pedal electrically connected to and controlling a valve in the at least one first handle fluid line.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a dental instrument with a blade with a single aperture and two handle fluid lines joining at a joint.

FIG. 2 is a dental instrument with a blade with two apertures, each connected to separate head and handle fluid lines.

FIG. 3 is a dental instrument with a spatula and two handle fluid lines arranged coaxially.

FIG. 4 is a dental instrument with a spatula and an interior valve controlled by a switch on the handle.

FIG. 5 shows a perspective view of a disassembled handle with a threaded nut and an instrument head with a complementary thread.

FIG. 6A shows a perspective view of a disassembled instrument head with a male cam-lock coupling and a handle with a complementary female cam-lock coupling.

FIG. 6B shows a top section view of the instrument head and handle of FIG. 6A in a connected, locked state.

FIG. 7A shows an instrument head with a blade.

FIG. 7B shows an instrument head with a blade.

FIG. 7C shows an instrument head with a blade.

FIG. 7D shows an instrument head with a blade.

FIG. 7E shows an instrument head with a blade.

FIG. 7F shows an instrument head with a blade.

FIG. 8A shows an instrument head with a spike.

FIG. 8B shows an instrument head with a spike.

FIG. 8C shows an instrument head with a spike.

FIG. 8D shows an instrument head with a spike.

FIG. 9A shows an instrument head with a spatula.

FIG. 9B shows an instrument head with a spatula.

FIG. 9C shows an instrument head with a spatula.

FIG. 9D shows an instrument head with a spatula.

FIG. 9E shows an instrument head with a spatula.

FIG. 9F shows an instrument head with a spatula.

FIG. 10A shows an instrument head with a hook.

FIG. 10B shows an instrument head with a hook.

FIG. 10C shows an instrument head with a hook.

FIG. 11A shows an instrument head with a fork.

FIG. 11B shows an instrument head with a fork.

FIG. 11C shows an instrument head with a fork.

FIG. 11D shows an instrument head with a fork.

FIG. 11E shows an instrument head with a fork.

FIG. 11F shows an instrument head with a fork.

FIG. 12A shows an instrument head with a bead.

FIG. 12B shows an instrument head with a bead.

FIG. 12C shows an instrument head with a bead.

FIG. 12D shows an instrument head with a bead.

FIG. 13A is a perspective view of a blade with a perpendicular aperture opening.

FIG. 13B is front view of FIG. 13A.

FIG. 14A is a perspective view of a spatula with two apertures facing each other.

FIG. 14B is a front view of FIG. 14A.

FIG. 15 is fork with two apertures facing each other across a gap.

FIG. 16 is a dental instrument assembly with a foot pedal connecting to a pumping module.

FIG. 17 is a dental instrument with a foot pedal connected to a valve in the handle.

### DETAILED DESCRIPTION OF THE EMBODIMENTS

Embodiments of the present disclosure will now be described more fully hereinafter with reference to the accompanying drawings, in which some, but not all embodiments of the disclosure are shown. In the drawings, like reference numerals designate identical or corresponding parts throughout the several views.

According to a first aspect, the present disclosure relates to a dental instrument that has an elongated handle with a hose end and a head end. The dental instrument handle 10 may have a length of 40-200 mm, preferably 70-180 mm, more preferably 80-150 mm, and a width or diameter of 4-30 mm, preferably 7-20 mm, more preferably 7-15 mm. Preferably the handle is straight, but in an alternative embodiment the handle may be curved and/or angled. Preferably the handle may comprise a biocompatible metal, such as stainless steel, aluminum, cobalt, zirconium, titanium, or some other metal. However, non-metals may be used in the handle such as polylactic acid (PLA), poly(lactic-co-glycolic acid) (PLGA), polyvinylchloride (PVC), polyethylene terephthalate (PET), acrylonitrile butadiene styrene (ABS), polypropylene (PP), polystyrene (PS), polytetrafluoroethylene (PTFE), polyetheretherketone (PEEK), polyetherketoneketone (PEKK), polycarbonate (PC), glass, carbon fiber, and/or ceramic. Preferably the handle is sterilizable by autoclave or other means. In one embodiment, the exterior surface of the handle may comprise a different material than its core or interior. The exterior surface of the handle may be polished or treated in a way to reduce glare or reflection. The handle may have a cylindrical shape or may have a prismatic shape, such as a hexagonal or triangular prism, to improve finger grip. In another embodiment, a portion of the handle may taper to a larger or smaller diameter, for example, the diameter of the handle may decrease towards the hose end. To further improve finger grip, a portion or segments of the exterior surface of the handle may comprise ribs, ridges, grooves, knurls, bumps, or some other texture. The instrument handle may have a cushion on the exterior surface for the same purpose. This cushion may comprise an elastomeric compound such as silicone rubber, latex, butyl rubber, neoprene, and/or nitrile, and may be solid or comprise air pockets. The cushion may have a height or thickness of 1 mm-4 mm, preferably 1.5-3 mm, more preferably 1.6-2 mm. The instrument handle may also comprise a ruler, for example, markings on the exterior surface to show a scale of centimeters and/or millimeters. In an alternative embodiment, the handle may comprise a light source, such as an LED, for illumination within a patient's mouth.

Within the handle is at least one first handle fluid line 12 that traverses the handle from the hose end 14 to the head end 16. This fluid line may simply be a hole traversing the handle, or the fluid line may be a hole traversing the handle but lined with a material different than the bulk of the handle, which material may be any of those discussed previously. In an alternative embodiment, the handle is hollow, with the fluid line comprising tubing that is threaded through the hollow space. The fluid line may transport a fluid used in dental hygiene and dental surgery procedures, including, but not limited to, air, nitrous oxide, water, saline solution, antiseptic solution, anesthetic solution, fluoride solution, sodium hypochlorite solution, EDTA solution, chlorhexidine solution, hydrogen peroxide solution, citric acid solution, detergent solution, lactated Ringer's solution, povidone-iodine solution, mouthwash, or any combination thereof. As used herein, the term “fluid” is defined as a gas, a liquid, a substance which flows, or a substance which differs from a solid in that it can offer no permanent resistance to change of shape. This definition also includes mixtures of gases, mixtures of liquids, and mixtures of gases and liquids. However, in an alternative embodiment, the instrument may deliver a mixture of powder and fluid, for example, glycine or sodium bicarbonate powder and air, to polish or clean the surface of a tooth. The fluid line may also transport an aspirate taken from the mouth of a patient during a dental hygiene or dental surgery procedure. This action may occur by the fluid line containing a negative pressure, or a pressure less than the ambient or atmospheric pressure. As used herein, the terms “deliver a suction” and “deliver an aspiration” refer to a fluid line under negative pressure or an aperture connected to such a fluid line, and which may or may not be collecting a liquid aspirate but is able to collect a portion of an adjacent volume of air. The aspirate may be any of the previously mentioned fluids, or a body fluid including but not limited to saliva, blood, vomit, plasma, and/or pus. In one embodiment, the aspirate may include small solids from the patient's mouth, such as pieces of soft tissue, bone, hard tissue, mucus, coagulated blood, dental implant, biofilm, plaque, food, calculus, sealant, amalgam, resin, or other restorative dental materials. The fluid line may have an inner diameter of 0.2 mm-10 mm, preferably 0.5 mm-5 mm, more preferably 0.8 mm-3 mm. The fluid line may accommodate flow rates of up to 20 mL/min, preferably up to 30 mL/min, more preferably up to 40 mL/min, and pressures up to 50 kPa, preferably up to 70 kPa, more preferably up to 90 kPa.

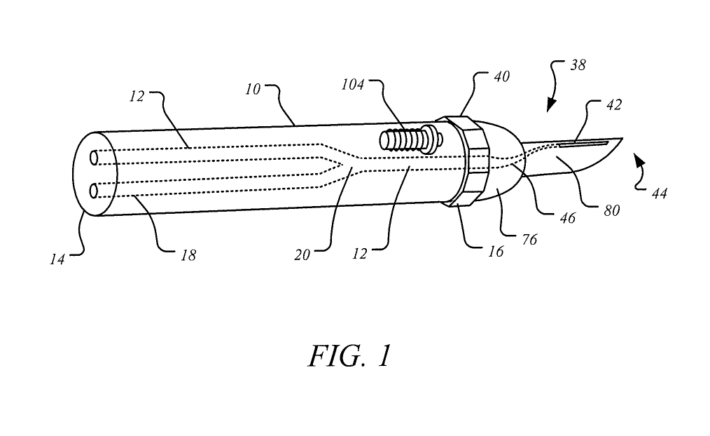

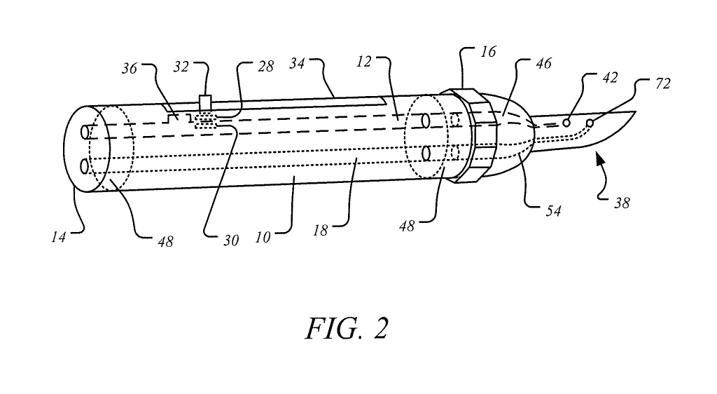

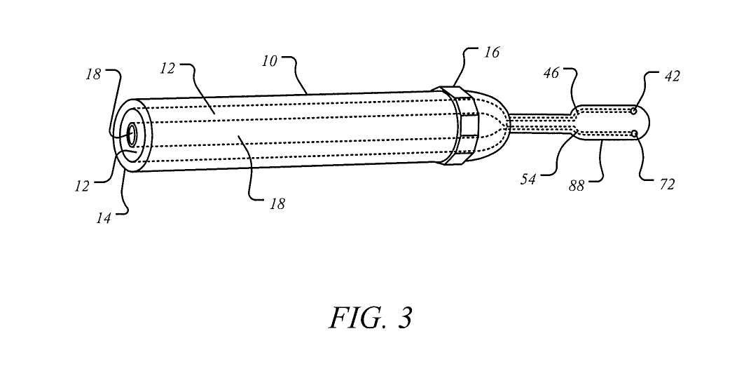

The handle has at least one second handle fluid line 18 that is also connected to the hose end. This second handle fluid line may be similar to the first handle fluid line, or it may have a different property, such as comprising a different material or having a different inner diameter. In one embodiment, shown in FIG. 1, the second handle fluid line 18 traverses from the hose end to a joint 20 of the first handle fluid line 12. In another embodiment, shown in FIG. 2, the second handle fluid line 18 traverses the handle from the hose end 14 to the head end 16. The two fluid lines may be arranged parallel to each other in a portion of the handle, or may be arranged coaxially, as in FIG. 3. In an alternative embodiment, the two fluid lines may be twisted around each other. In another embodiment, the handle may comprise an otherwise cylindrical cavity divided into two halves along its length from the hose end to the head end, with each half cylinder cavity comprising a fluid line.

Where the second handle fluid line connects to a joint on the first handle fluid line, the two fluid lines may be in fluid communication with each other. This joint may be located anywhere along the first fluid line, and may be within a middle portion of the handle's length, such as within 40-60%, or 45-55%, or 48-52%, or about 50% of the length of the handle from the handle midpoint. Alternatively the joint may be located within the half, preferably within the third, of the length of the handle adjacent to the head end. In one embodiment, the handle may comprise more than two fluid lines, which may or may not be in fluid communication with each other, and may or may not connect at one or more joints. For example, more than two handle fluid lines may traverse and be disposed in the handle from the hose end to the head end. In another embodiment, more than two fluid lines may come to a single joint, and the joint may have any number of fluid lines configured as inlets and outlets. In one example, a single handle fluid line may reach a joint where it may split into two or more handle fluid lines. In an alternative embodiment, one or more handle fluid lines may traverse from the hose end to the head end but may be attached to an external surface of the handle.

In one embodiment, where the second handle fluid line 18 connects to the first handle fluid line 12 at a joint 20, the joint further comprises a valve 22 to regulate the fluid flow. For instance, the valve may switch between two positions. In the first position, a fluid in the first handle fluid line may be able to flow between the head end and the hose end, while preventing flow in the second handle line. In the second position of the valve, a fluid may flow within the second head fluid line between the hose end and the joint and within the first head fluid line between the joint to the head end. The valve may further have a third position, where it blocks flow in both fluid lines. The valve may also have a position where it allows flow in both fluid lines. In an alternative embodiment, the same flow conditions may be created by two separate valves located on two fluid lines that connect at a joint. In an alternative embodiment, the valve may be able to reduce flow without blocking it entirely. For example, the valve may be able to reduce the flow rate in the first handle fluid line by 30-90%, preferably 40-80%, more preferably 50-80%. In the embodiment where the two handle fluids lines do not intersect, each fluid line may comprise a valve. Additionally, joints of any number of inlets or outlets, as described previously, may or may not have a valve. In an alternative embodiment, a joint or a segment of a fluid line may have an impeller or some other mixing device to mix different fluids arriving from separate fluid lines. In an alternative embodiment, a valve may exist on a fluid line that is not part of a joint, and the valve may be configured to only allow fluid flow in one direction.

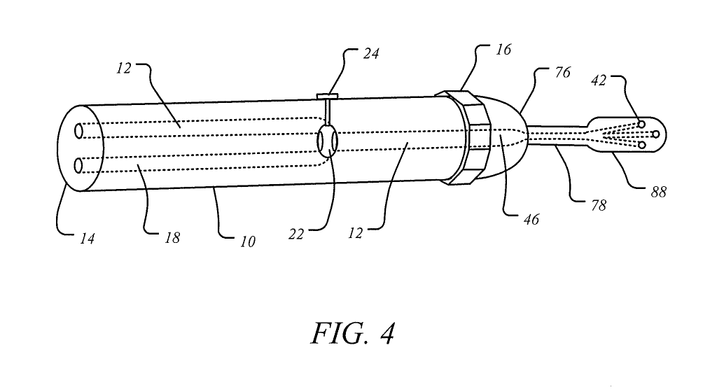

In the embodiment where the second handle fluid line connects to the first handle fluid line at the joint 20 which comprises a valve 22, the exterior surface of the handle may have a button or a switch 24 to control the valve, as shown in FIG. 4. This button or switch may be mechanically connected to the valve, or it may be electrically connected to a motor or actuator that controls the valve. The button or switch may be able to control the valve in any of the previously mentioned positions. Where the handle comprises fluid lines that are not in fluid communication with each other, the handle may have buttons or switches to separately control valves on those fluid lines. In one embodiment, the valve may be electrically connected to and controlled by a foot pedal 130 (to be discussed in more detail below), rather than a button or switch on the handle. In another alternative embodiment, the valve may be controlled through a wireless transmission from the foot pedal. In one embodiment, the valve may be able to measure a volume of a fluid delivered to the instrument head, and this measurement may or may not be regulated by electronic circuitry in the instrument handle.

In one embodiment, a slidable plunger 30 may be disposed in the first handle fluid line or the second handle fluid line. In one embodiment, the first handle fluid line and the second handle fluid line may each have a slidable plunger. The plunger may be a rod or an ellipsoid with a length of 4-30 mm, preferably 5-15 mm, more preferably 7-12 mm. The maximum width or diameter of the plunger may be less than 80%, preferably less than 60%, more preferably less than 40% of the width of the handle fluid line. The outside surface of the plunger may comprise stainless steel, polypropylene, polystyrene, polytetrafluoroethylene, polycarbonate, or a previously mentioned material. The plunger may be of a material and shape that allow it to slide within a curved fluid line. In one embodiment, the plunger 30 may contain a magnet with an attraction to a second magnet 28 outside the fluid line but within the handle. The second magnet may be connected to a tab 32 projecting from a slot 34 in the handle, allowing a user to move the plunger by moving the tab. In one embodiment, the tab is connected directly to the plunger with no magnets involved. Preferably the movement of the plunger may be able to dislodge a solid impeding fluid flow, for example, a solid aspirate. A handle fluid line that has a plunger may have a segment with a larger diameter or a recession 36 where the plunger can be located without significantly impeding fluid flow.

The dental instrument also has an instrument head 38 with a connection end 40 and at least one first aperture 42 at a distal end 44. This instrument head is removably attached to the head end 16 of the handle through the connection end 40. Within the instrument head 38 is at least one first head fluid line 46 traversing between the connection end 40 and the at least one first aperture 42, and the first handle fluid line 12 is in fluid communication with the first head fluid line 46. The head fluid lines may be of similar structures and dimensions as described for the handle fluid lines. Alternatively, a portion of a head fluid line near the aperture may be a smaller diameter than a handle fluid line. In one alternative embodiment, the handle has only one handle fluid line and the instrument head has only one head fluid line, and both are connected in fluid communication.

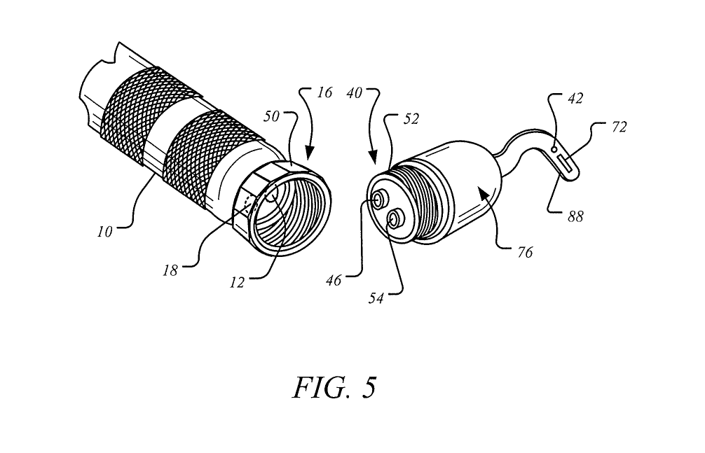

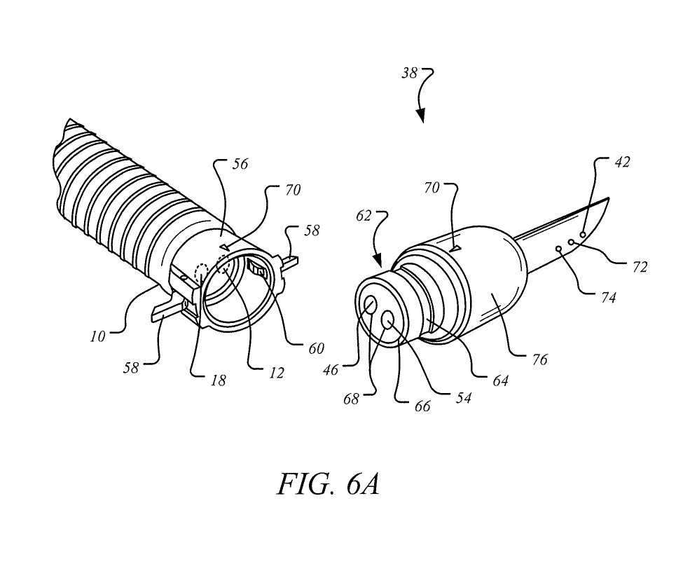

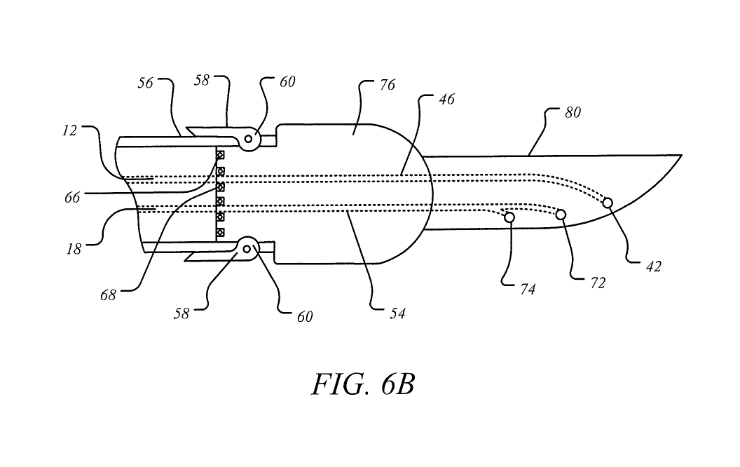

The removable attachment between the instrument head and the handle may involve joining one or more fluid lines so that they connect in fluid communication between the handle and the instrument head. At the head end of the handle, preferably the handle fluid lines are rigidly secured. For example, in the embodiment where the handle is hollow with one or more handle fluid lines threaded through, preferably the handle fluid lines at the handle ends are secured in a solid insert 48, such as a washer or a plug, as shown in FIG. 2. In one embodiment, the removable attachment mechanism between the handle and the instrument head may involve a screw thread connection. The instrument head may be a female connector and the handle may be a male connector, or vice versa, and preferably an O-ring or other elastomeric material may be used to seal the connection against leaks. Alternatively, the screw thread connection may comprise a nut or a sleeve with a screw thread. FIG. 5 shows the head end 16 of a handle with a threaded nut 50, configured to connect to the threaded connection end 52 of the instrument head. This connection establishes fluid communication between a first handle fluid line 12 and a first head fluid line 46 and between a second handle fluid line 18 and a second head fluid line 54. In one embodiment, the connection may be an unthreaded fitting that may be secured and sealed by a clip, a lever, a washer, a spring-loaded latch, and/or an O-ring. The connection may involve a ball-lock coupling, a roller-lock coupling, a pin-lock coupling, a flat-face coupling, a bayonet coupling, a ring-lock coupling, a cam-lock coupling, or some other structure. Preferably the fitting allows a user to separate and connect the handle and the instrument head without the use of a tool. FIG. 6A shows a disconnected instrument head 38 and handle 10, each with two fluid lines and a cam-lock coupling. The female cam-lock coupling 56 at the head end of the handle has levers 58 that connect to cams 60 that protrude into the interior of the coupling when the levers are in a locked position. The complementary male cam-lock coupling 62 is located at the connection end of the instrument head, and has an annular groove 64 that accommodates the cams when the levers are in a locked position. Exterior O-ring 66 and interior O-rings 68 provide seals. FIG. 6B shows the same instrument head and handle of FIG. 6A, but in an attached state.

In a related embodiment, where the handle is traversed by two handle fluid lines from the hose end to the head end, and the instrument head has two head fluid lines connected to the connection end, the handle and the instrument head may be rotatably and removably attached in such a way that rotating the instrument head circumferentially relative to a longitudinal axis of the handle may block and/or exchange fluid communication between the handle and head fluid lines. For example, the attached handle and instrument head may provide fluid communication between the first handle fluid line and the first head fluid line, and between the second handle fluid line and the second head fluid line. From this initial state, rotating the instrument head clockwise or counterclockwise 75°-105°, preferably 80°-100°, more preferably 85°-95°, or about 90° may sever the fluid communication between the lines, blocking the flow of a fluid in both handle fluid lines and both head fluid lines. Rotating the instrument head to a second position or a second range of positions may establish fluid communication between the first handle fluid line and the second head fluid line, and between the second handle fluid line and the first head fluid line. This second position may be a clockwise or counterclockwise rotation of 176°-184°, preferably 178°-182°, or about 180° from the initial state. This structure may enable a user to block the fluid flow in one or more lines, or to exchange or reverse a fluid flow experienced by the instrument head in one or more lines. Certain rotated positions may not completely block the fluid flow but instead decrease the flow rate. This type of rotation may be enabled by an unthreaded connection where the fluid lines meet at a flat interface that can be rotated without having to separate the instrument head and the handle. The fluid lines at the connection end and the head end may be arranged with a rotational symmetry in relation to the axis of rotation.

As an example of this embodiment, FIG. 6B shows a top section view of the instrument head and handle of FIG. 6A attached to each other. The instrument head and handle may be connected with the arrows 70 inline (seen in FIG. 6A). Here, the first handle fluid line 12 may be in fluid communication with the first head fluid line 46 and a first aperture 42, while the second handle fluid line 18 may be in fluid communication with the second head fluid line 54 and both a second 72 and third aperture 74. When the instrument head is rotated clockwise or counterclockwise 180° relative to the handle while connected, then the first handle fluid line 12 may be in fluid communication with the second head fluid line 54 and both the second 72 and third aperture 74, while the second handle fluid line 18 may be in fluid communication with the first head fluid line 46 and the first aperture 42.

Preferably a visual indicator such as a line or an arrow 70 may exist on the exterior of the handle or the instrument head in order to distinguish one or more rotatable positions. Alternatively, the connection may be shaped in a way that the rotated positions connecting the lines have a tactile resistance or a change in the spacing between the handle and the instrument head. This way a user can feel the different positions while rotating the instrument head. In an alternative embodiment, more than two head fluid lines and more than two handle fluid lines may comprise this type of rotational exchange connection. In another alternative embodiment, in order to exchange fluid communication among two or more handle fluid lines with two or more head fluid lines, the instrument head may be detached, rotated relative to the handle, and then reattached. For example, this may be done with the instrument in FIG. 5, which may not otherwise allow rotation of the instrument head relative to the handle while attached.

In another alternative embodiment, the rotational exchange connection may exist in a part of the handle away from the head end, or in the connection between a hose and the hose end of the handle. In the embodiment where the handle comprises two or more coaxially-arranged handle fluid lines, those handle fluid lines may connect to the same number of coaxially-arranged head fluid lines. In that embodiment, the connection may be rotatable, but rotating the instrument head relative to the handle may not modify the fluid communication of the head fluid lines and/or the handle fluid lines. In another related embodiment where only one head fluid line is connected to only one handle fluid line, rotating the instrument head may or may not influence the fluid communication between those two fluid lines.

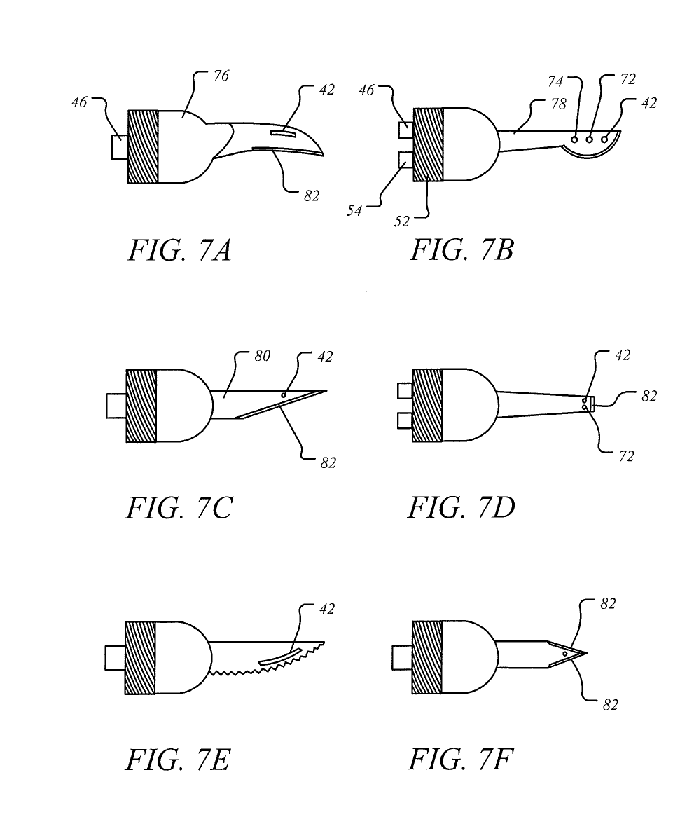

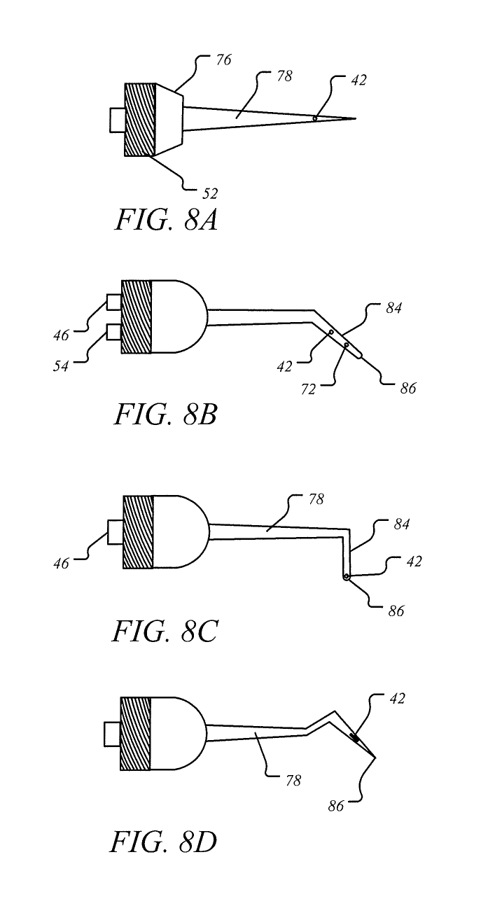

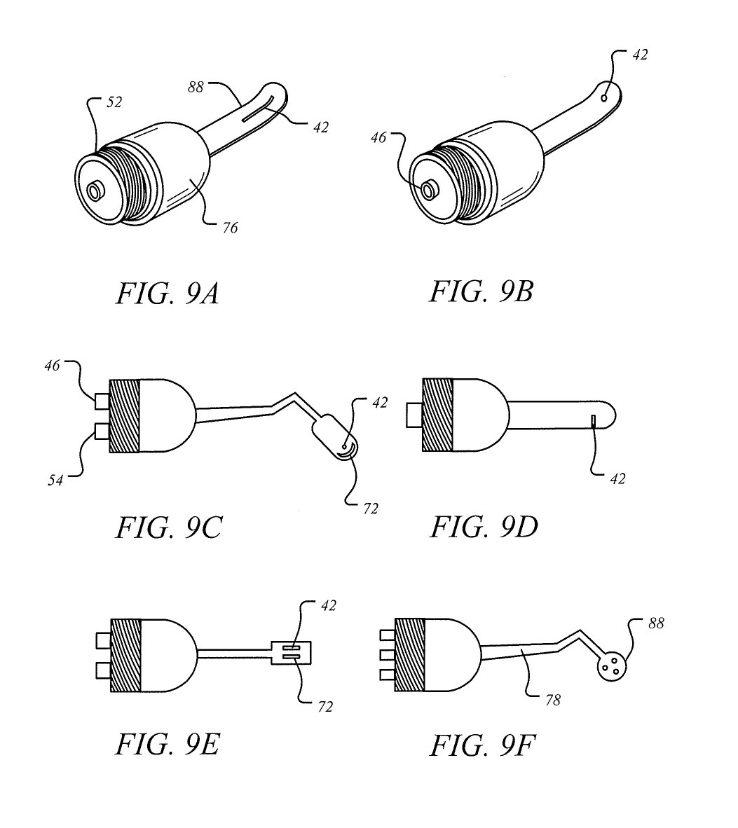

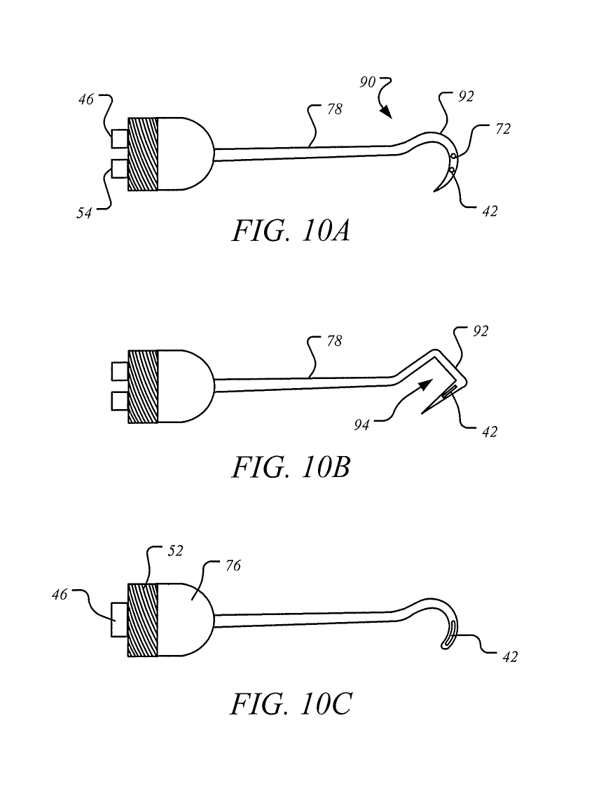

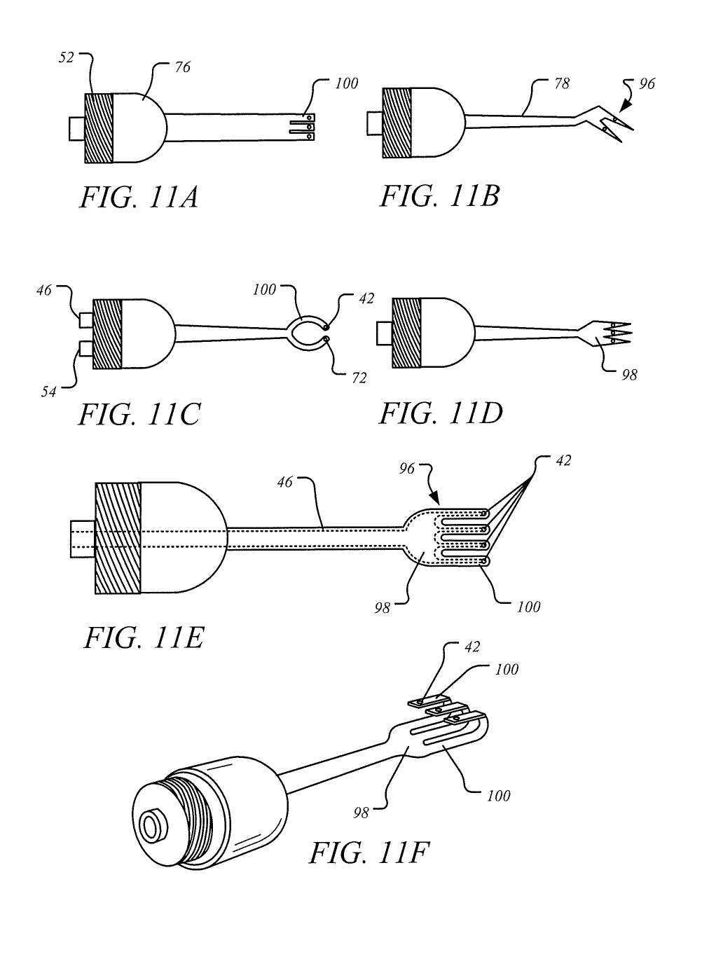

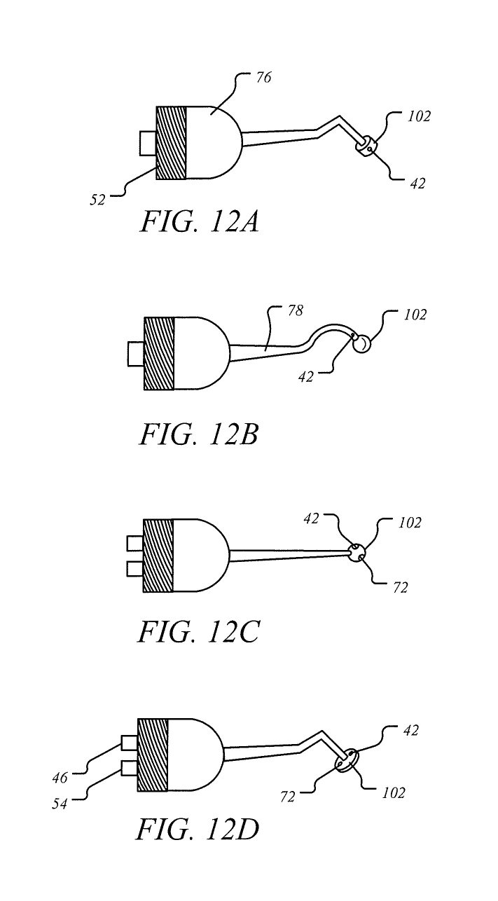

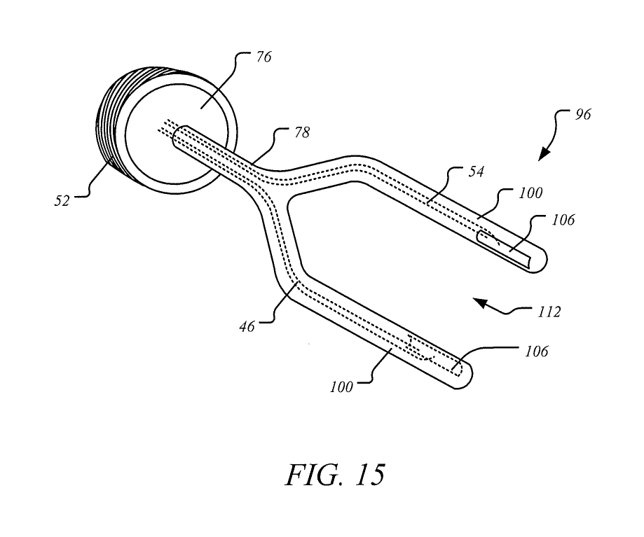

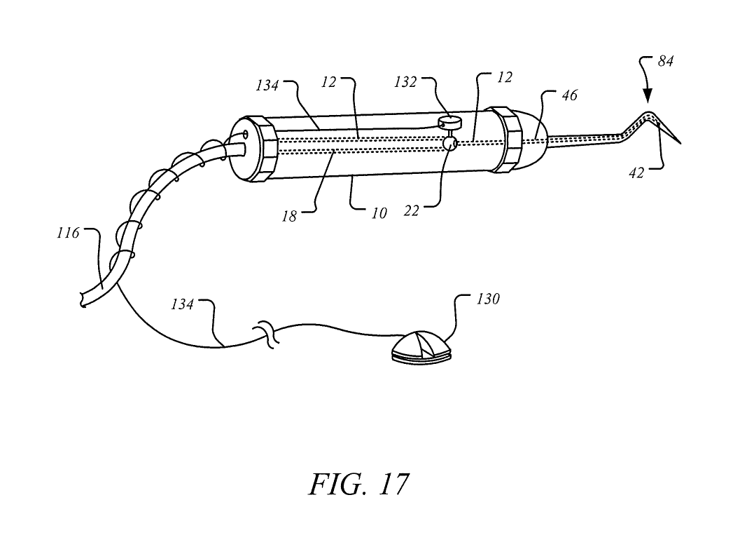

The instrument head may comprise a blade, a spike, a spatula, a hook, a fork, a bead, or any combination thereof. The instrument may be used in dental hygiene, dentistry, periodontal procedures, endodontic procedures, orthodontic procedures, cosmetic dentistry, oral surgery, rhinoplastic procedures, ENT procedures, or other medical procedures, for use on humans and/or non-human animals. In alternative embodiments, the instruments may be used for other purposes, including but not limited to surgical procedures, dermatology procedures, ophthalmology procedures, mortuary procedures, autopsy, biopsy, archaeological excavation, cosmetic surgery, make-up arts, sculpture, historic preservation, art conservation, book arts, culinary arts, manufacturing, biology, botany, chemistry, and/or cell culture. A single instrument name may refer to different instrument shapes and/or different uses. For example, a “plugger” may refer to an amalgam restoration tool and/or a root canal tool, and pluggers may comprise a spike, a spatula, a hook, and/or some other form. In addition, one type of instrument may be used for different purposes, for example, a hook-shaped scaler may also be used as an explorer. The instrument head may comprise a mount 76 adjacent to the connection end, and the side of the mount opposite to the connection end may taper to a smaller diameter shaft 78 which connects to a functional structure at the distal end. As defined here, the “functional structure” refers to the smallest segment of the instrument head that may still be considered a blade, spike, spatula, hook, fork, and/or bead. The mount may comprise the attachment mechanism, and may comprise stainless steel or any of the previously mentioned materials that may comprise the handle. The mount may be about the same diameter as the head end of the handle, and may have a length of 2-10 mm, preferably 3-9 mm, more preferably 3-7 mm. The shaft may have a diameter throughout its length of 1-10 mm, preferably 2-8 mm, more preferably 2-6 mm. Alternatively, the shaft may have a widest diameter about the same as the head end of the handle where it connects to the mount, and may taper to a smaller diameter. Alternatively, the shaft may have a smaller diameter throughout its length but without a taper from the mount. The shaft and the functional structure preferably comprise the same material, such as those listed previously for the handle, but they may comprise different materials. Preferably both the shaft and functional structure comprise stainless steel. In one embodiment, the functional structure may be connected directly to the mount without a shaft, such as the blade 80 connected to the mount 76 in FIG. 1. In an alternative embodiment, the instrument head may have no mount and no shaft, and may only consist of the functional structure. In an alternative embodiment, the instrument head may comprise a light source, such as an LED, for additional illumination.

Where the instrument comprises a blade, the instrument head may be a knife, a razor, a surgical scalpel blade in the shape of or similar to number 9, 10, 10A, 11, 12, 12B, 12D, 13, 14, 15, 15A, 15B, 15C, 15D, 15S, 16, 17, 18, 19, 20, 21, 22, 22A, 23, 24, 25, 25A, 26, and/or number 36 scalpel blades, or some other scalpel blade. FIGS. 1, 2, 6A, 6B, 7A-7F, 13A and 13B show embodiments of instrument heads comprising different blades and different aperture configurations. The blade may have a cutting edge 82 which may be curved, straight, angled, serrated, or a combination. The blade may have more than one cutting edge, for instance, on opposing edges like a lancet, as in FIG. 7F. The blade may have a length of 5-40 mm, preferably 10-30 mm, more preferably 10-25 mm, a cutting edge of a length 1-30 mm, preferably 3-20 mm, more preferably 4-15 mm, a widest width of 3-20 mm, preferably 5-15 mm, more preferably 7-10 mm, and a largest thickness of 1-10 mm, preferably 2-6 mm, more preferably 2-4 mm.

Where the instrument head comprises a spike, the instrument head may be a dental probe, a dental scaler, a dental explorer, a dental plugger, a dental spreader, a root canal file, a dental packer, an osteotome, a periotome, a sinus lift, a root tip pick, a carver, and/or a different tool. FIGS. 8A-8D, and 17 show instrument heads with different spike and different aperture configurations. The spike shape may have the same central axis as an interior longitudinal axis of the handle and/or shaft 78, as in FIG. 8A, but preferably the spike shape 84 may be bent from one or more angles, as in FIGS. 8B-8D. The spike may have a length of 5-60 mm, preferably 7-40 mm, more preferably 10-30 mm. The widest diameter of the spike at its base may be 1-10 mm, preferably 2-8 mm, more preferably 2-6 mm. The distal end or tip 86 of the spike may be rounded, pointed, and/or flattened. FIG. 8D shows a pointed tip and FIG. 8B shows a rounded tip. A portion of the spike may comprise concentric markings spaced at certain intervals, such as those of a dental probe.

Where the instrument head comprises a spatula, the instrument head may be a dental elevator, including a periosteal elevator, a dental chisel, a dental file, a dental hoe scaler, a dental packer, a retractor, a curette, a carver, and/or a different tool. FIGS. 3, 4, 5, 9A-9F, 14A and 14B show instrument heads with different spatula and aperture configurations. The spatula may comprise a rounded or rectangular shape 88 at the end of a shaft 78 as in FIG. 9F or may connect directly to the mount, as in FIG. 9D. The spatula shape may have a width of 1-25 mm, preferably 1-20 mm, more preferably 1-5 mm, and a length of 1-25 mm, preferably 3-15 mm, more preferably 4-10 mm. The thickness may be about 0.2-3 mm, preferably 0.4-2 mm, more preferably 0.5-1 mm, though one or more edges may be thinner. The spatula may be planar or curved, and the connection with the shaft may be coplanar or at an angle. The face of the spatula may be smooth or comprise a rough texture or an additional hardened element, such as a dental file.

Where the instrument head comprises a hook, the instrument head may be a dental probe, a dental scaler, a dental explorer, a dental chisel, a periotome, a retractor, a sinus lift, a rake retractor, a curette, a carver, and/or a different tool. FIGS. 10A-10C show different configurations of hooks and apertures. The shape of the hook 90 may comprise a shank 92 that is angular, rounded, or some combination. The hook may be shaped so that the shank partially and approximately encloses an elliptical or rectangular gap or eye 94 with a height of 2-30 mm, preferably 3-20 mm, more preferably 3-12 mm, and with a width of 2-30 mm, preferably 3-20 mm, more preferably 3-12 mm. The widest diameter of the shaft 78 before curving or bending into a hook shape may be 1-10 mm, preferably 2-8 mm, more preferably 2-6 mm, and may taper through the length of the shank to end with a rounded, pointed, or angled tip. The shape of the hook may lie in a plane that also includes the plane of the shaft, though in a preferred embodiment, they lie in different planes. The shank itself may bend or curve out of a single plane. The shank may have smooth edges, like a dental explorer, or may have sharp or defined edges, such as a dental scaler. The shank may comprise a rough surface as a file or may comprise an additional hard material, such as diamond. The shank may have markings on its surface spaced at certain intervals. In one embodiment, a dental instrument that comprises a spike with one or more bends, angles, and/or curves may also comprise a hook.

Where the instrument head comprises a fork, the instrument head may be a rake retractor, a periosteal elevator, and/or a different tool. FIGS. 11A-11F and 15 show different configurations of forks and apertures. The shape of the fork 96 may comprise 2-6 prongs 100, preferably 2-5 prongs, more preferably 2-4 more prongs, though in one embodiment the fork may comprise more than 6 prongs. The shape may be the same as or similar to a shaft comprising two or more spikes. A flat hub segment 98 may connect the prongs 100 to the shaft, and this hub segment may have a height of 2-30 mm, preferably 3-20 mm, more preferably 3-12 mm, a width of 2-30 mm, preferably 3-20 mm, more preferably 3-12 mm, and a thickness of 0.2-3 mm, preferably 0.4-2 mm, more preferably 0.5-1 mm. The prongs 100 may be in the shape of a spike, similar to FIG. 11B, and may have cross-sections that are circular, elliptical, rectangular, hexagonal, or some other shape, and may taper to a rounded, flat, or pointed tip, or a tip of some other shape. The prongs may have a length of 3-30 mm, preferably 5-20 mm, more preferably 5-15 mm. The widest diameter of the prongs at their connection to the flat hub segment may be 0.5-5 mm, preferably 1-4 mm, more preferably 1-3 mm, and the prongs may be spaced by these amounts or less. In one embodiment, the sides of the prongs are angled and the inner sides of adjacent prongs intersect the flat hub segment at a point, as shown in FIG. 11D. Preferably the prongs are substantially parallel to one another, which is defined as at least two prongs in the same plane having longitudinal axes that form an angle less than 10°, preferably less than 5°, more preferably less than 2°, where exactly parallel prongs form no angle because the parallel axes do not intersect. FIG. 11A shows a fork with parallel prongs 100. In an alternative embodiment, at least two prongs have longitudinal axes that form an angle 50° or less, preferably 30° or less, more preferably 25° or less. The prongs and the flat hub segment may lie in a single plane, or one or both may curve in the same direction, similar to a dinner fork. In one embodiment, the prongs may be curved, bent, and/or angled to point back in the direction of the connection end, so that each prong has a hook shape, as shown in FIG. 11F. In this embodiment, the instrument head may be a rake retractor. In one embodiment, a fork comprises two prongs that extend and then curve towards each other, as shown in FIG. 11C. In another embodiment, similar to the instruments with spikes, one or more prongs may have markings at certain intervals.

Where the instrument head comprises a bead, the instrument head may be a dental excavator, a root canal plugger, a burnisher, a dental packer, a sinus lift, a curette, and/or a different tool. FIGS. 12A-12D show different configurations of beads and apertures. Here, the functional head may be the same or similar geometry described for the hook and/or spike shapes but also comprises a bead shape 102 which is defined by its larger diameter at the end of the shank 92 or shaft 78. The shape may be a cylinder, an ellipsoid, a ball, a prism, a prismoid, a pyramid, or some other form with curved and/or angled edges. The bead shape may have a widest width of 1-12 mm, preferably 2-8 mm, more preferably 3-6 mm, and a length of 2-11 mm, preferably 2-8 mm, more preferably 3-6 mm. In some embodiments, a single instrument head may be considered to have both a spatula shape and a bead shape, such as certain sinus lift instruments.

In an alternative embodiment, other dental, periodontal, orthodontic, and other medical tools may be adapted for use similar to the dental instruments described. These tools include, but are not limited to a drill, a dental mirror, a hemostat, a needle holder, a pair of forceps, a pair of scissors, a polisher, a crown remover, a surgical laser, a clamp, a camera, a light, a pair of nippers, a band pusher, a debrider, a ring, a ligature director, a brush, a toothbrush, a floss holder, a tongue scraper, a thermometer, or a toothpick. In one alternative embodiment, a brush composed of capillary fibers may be used with the capillaries capable of carrying fluid or aspirate. Preferably the instrument head may be sterilized by autoclaving or a different method. Preferably the instrument head is capable of polishing and/or sharpening if needed, for instance, a blade or a scaler may be sharpened between uses. In an alternative embodiment, the instrument head may be made entirely of a polymeric material, such as those mentioned previously, and may be disposable.

In one embodiment, the dental instrument may comprise an ultrasonic transducer 104 in the handle or the instrument head. The ultrasonic transducer may be a piezoelectric or magnetorestrictive transducer or some other type, and the ultrasonic vibrational energy may assist in the tool's function, such as a scaler having ultrasonic vibrations to more easily dissociate plaque and/or calculus from a surface of a tooth. FIG. 1 shows a dental instrument with an ultrasonic transducer 104 disposed in the handle 10. In an alternative embodiment, a transducer may create vibrations at a lower frequency than ultrasonic, for example, sonic vibrations, which may be used for the same purpose. In a related embodiment, a sonic or ultrasonic transducer may be used to break up a solid that is clogging a head or handle fluid line.

Alternatively, in a related embodiment to unclog a head fluid line, a portion of a head fluid line may be reached by a slidable plunger extending from a handle fluid line. Alternatively, a head fluid line may have its own slidable plunger disposed within, similar to that described earlier for the handle fluid line.

As mentioned previously, the dental instrument head may have at least one aperture at an end distal to the connection end, and the connection end and the at least one aperture are connected by at least one head fluid line. The aperture may be in the shape of a circle with a diameter of 0.5-5 mm, preferably 0.7-3 mm, more preferably 0.8-2 mm. In an alternative embodiment, the aperture may be smaller, in order to deliver a mist of a fluid. The aperture may instead be an elongated shape, such as an ellipse, and oval, a rectangle, a hemisphere, or some other shape with curved, straight, and/or angled edges. For an elongated shape, the longest dimension may be 2-20 mm, preferably 4-15 mm, more preferably 5-10 mm, and the shortest dimension may be 0.5-5 mm, preferably 0.7-3 mm, more preferably 0.8-2 mm. Preferably an elongated shape has a ratio of longest dimension to shortest dimension of 2:1-1,000:1, preferably 3:1-100:1, more preferably 4:1-20:1. FIG. 7A shows an aperture 42 with an elongated, rectangular shape. In one embodiment, an elongated aperture may be shaped so that it emits a flattened stream of fluid. The aperture may be located a farthest distance from the connection end, for instance, in the case of an instrument head comprising a spike, the aperture may be located at the tip 86 of the spike, such as FIG. 8C. In another embodiment, the aperture may not be located at an extreme distance from the connection end. For instance, the aperture may be located within the middle 30-80%, 40-60%, or 45-60% of the length of the instrument head. Alternatively the aperture may be located on an edge of the instrument head, such as the cutting edge of a blade, or within a plane of an instrument, such as a middle portion of a spatula shape. In another embodiment, an elongated aperture may span both an edge and a plane of an instrument head, for instance, a rectangular aperture may traverse between an edge and a central portion of a periosteal elevator, as in FIG. 9D. In an alternative embodiment, a fluid line may be located on an exterior surface of the instrument head or may extend near the instrument head. In this alternative embodiment, the aperture may be at the end of the fluid line and not necessarily be a part of the instrument head, and this fluid line may be disposed within or located outside the handle.

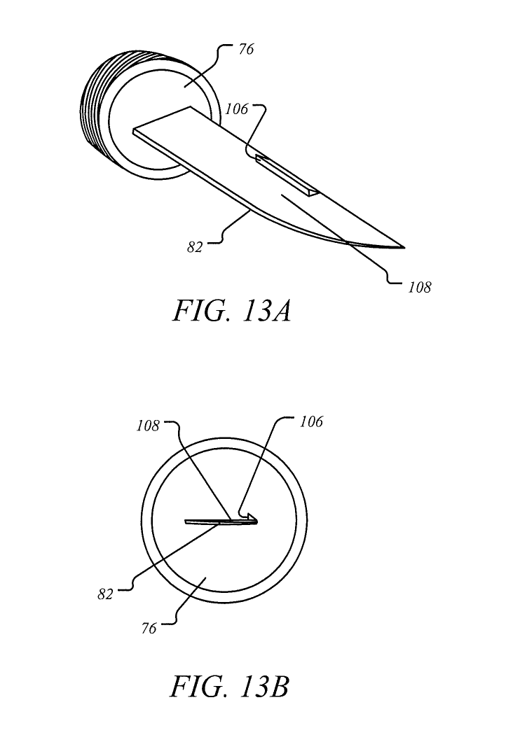

In the embodiments where an aperture is not located on an edge or a point of a dental instrument head, the edges of the aperture may be in the same plane as the face of the instrument head so that the aperture lies flush with the surface. Depending on flow rate, a fluid may exit such an aperture with a trajectory substantially perpendicular to that plane of the instrument head. As used herein, “substantially perpendicular” refers to an angle 70-110°, preferably 75-105°, more preferably 80-100°, where 90° is a true perpendicular angle, and here the angle refers to the angle between the trajectory and the adjacent plane of the instrument head. In other embodiments, the aperture may not lie flush with the surface. In this case the edges of the aperture define a plane that may be at an angle relative to the adjacent plane of the instrument head. Depending on flow rate, a liquid fluid may exit this type of angled aperture by flowing along the surface of the instrument head, and/or the fluid may be emitted away from the surface of the instrument head. In one embodiment, the plane enclosed by the edge of the aperture is substantially perpendicular to the adjacent surface of the instrument head. In this configuration, a liquid fluid may exit the aperture and be directed to flow across the surface of the instrument head at any flow rate. FIGS. 13A and 13B show a blade in this configuration where the plane of the aperture opening 106 is perpendicular to the surface of the blade 108. A liquid fluid delivered to the aperture may exit and flow across a portion of this surface.

In one embodiment, where the first handle fluid line is in fluid communication with at least one first head fluid line and at least one first aperture in the distal end of the instrument head, the instrument head has at least one second head fluid line disposed in and traversing from the connection end to at least one second aperture at the distal end, where a second handle fluid line traverses the handle from the hose end to the head end and is in fluid communication with the second head fluid line. An example is shown in FIG. 2. In an alternative embodiment, as mentioned with the handle fluid line configurations, two or more head fluid lines may or may not connect at joints, may or may not split or fan out, and may or may not comprise valves or mixers. In one embodiment, the instrument head has at least two first apertures in fluid communication with at least one first head fluid line. An example is shown in FIG. 4. In this configuration, the instrument may be able to deliver the same type of fluid to at least two different locations on the instrument head.

Where the instrument head comprises two or more apertures, those apertures may be adjacent or on opposite sides. The apertures may be connected to the same head fluid line or separate head fluid lines, and may be the same shape or different shapes, and may deliver fluids at the same or different flow rates and/or different pressures. The apertures may be located on the functional structure of the instrument and/or the shaft, and in an alternative embodiment, one or more apertures may be located on the mount. In one embodiment, the instrument head comprises at least two apertures where at least one delivers a liquid and at least one delivers a suction. In another embodiment, a single aperture may be able to connect in fluid communication with more than one fluid line contained in the instrument head or the instrument handle, in order for more than one type of fluid to be delivered. In a previously mentioned embodiment, two handle lines may connect at a joint controlled by a valve. If the valve output goes to a single head fluid line in fluid communication with at least one first aperture, as in FIG. 4, then the at least one first aperture may be able to deliver different fluids.

In one embodiment, the instrument head comprises a fork with a plurality of prongs, with the first aperture disposed at the end of each prong and in fluid communication with the at least one first head fluid line. The fork may have 2-6 prongs, preferably 3-5 prongs, and may have a structure and dimensions as described previously. FIG. 11E shows an example of this embodiment. In one embodiment, at least one aperture may face out from the tip of each prong, so that a fluid flowing out of the aperture may exit along the central axis of the prong. Alternatively, at least one aperture may be in a plane parallel with the largest plane of the flat hub segment. Alternatively, at least one aperture may be in a plane at an angle to or perpendicular with the flat hub segment. Alternatively, each prong may have more than one aperture on the same or different sides, or no apertures. Alternatively, the apertures may be disposed elsewhere on the fork, such as at the bases of the prongs, a middle portion of the prongs, or on the flat hub segment. In one embodiment, the prongs may be curved back towards the handle, as described previously and depicted in FIG. 11F, which is similar in form to a rake retractor. In one embodiment, one or more second apertures may be in fluid communication with at least one second head fluid line.

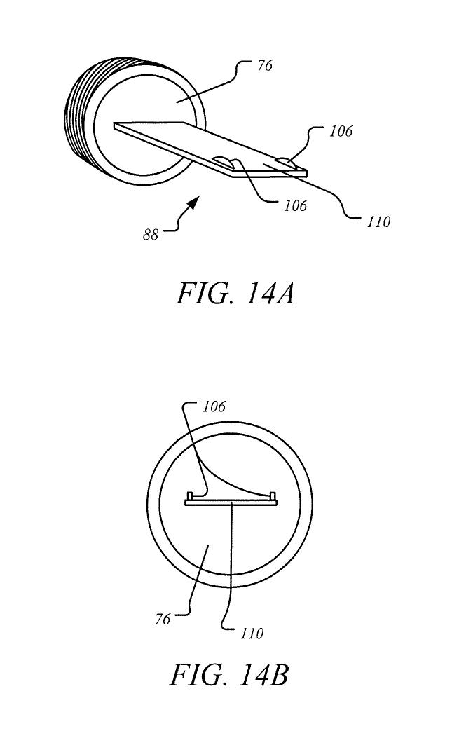

In one embodiment where the instrument head comprises at least one first aperture and at least one second aperture, a first plane enclosed by an edge of the at least one first aperture is substantially parallel with a second plane enclosed by a second edge of the at least one second aperture, and the first and second apertures face each other. In this configuration, one first aperture may emit a fluid while a second aperture aspirates the fluid. This configuration may be used to precisely irrigate a location without flooding it with excess liquid. In an alternative configuration, both apertures may emit a stream of fluid, and these streams may combine at a region near the midpoint of the two apertures. The apertures may be in fluid communication with the same head fluid line or with different head fluid lines. The space between the apertures may comprise a single surface, for example, the apertures may face each other on the same side of a spatula. FIGS. 14A and 14B show this embodiment where the aperture planes 106 face each other from opposite edges of the spatula 88 across a surface 110. Alternatively the apertures may be separated by a space or a lumen. In the embodiment where the apertures face each other and are separated by a space, the space may accommodate a tooth, a gum line, a tissue, an implant, or some other feature in a patient's mouth. In the configuration where both apertures emit streams of fluid, the feature may be irrigated simultaneously from more than one side. FIG. 15 shows an embodiment of this arrangement with a two-pronged fork 96 where both prongs 100 have an aperture plane 106 that faces the other aperture plane across a space 112. In an alternative embodiment, the aperture planes may be configured in a direction that is not facing each other but arranged so that an emitted stream of fluid from both apertures may intersect at a certain point.

The dental instrument may be part of a dental instrument assembly, where the dental instrument assembly also comprises a pumping module for the delivery of fluids and aspiration. The pumping module may have a hose that removably attaches to the hose end of the dental instrument handle. This attachment may allow the fluid communication between the pumping module and the handle fluid lines for the purpose of carrying an aspirate from the dental instrument head and/or delivering a fluid to the dental instrument head. This hose may comprise two or more hose fluid lines housed in a flexible conduit, and may also comprise an electrical wire or wires electrically connecting a switch or button on the handle with the pumping module. The hose fluid lines may be a similar diameter or larger than the handle fluid lines. The hose may be coiled or straight, and may have a total length of 0.5-3 m, preferably 1-2.5 m, more preferably 1.5-2.5 m. Where the dental instrument comprises a metal and/or electronics, the hose may comprise a grounding wire. The hose may also comprise an electrical connection for an ultrasonic transducer, a valve, a mixer, a pressure sensor, a flow sensor, a thermometer, an LED light, or other electronics in the instrument head or handle. In an alternative embodiment, the hose may comprise only one hose fluid line. In the embodiment where the instrument handle is hollow with handle fluid lines threaded through, each handle fluid line may be attached to a hose fluid line by separate attachment mechanisms. Alternatively, a single attachment mechanism may be able to removably attach multiple fluid lines. In general, the attachment mechanism between the hose and the hose end may be any of those mentioned previously for removably attaching the handle to the instrument head. Alternatively, the attachment may use fewer parts, such as a tubing and hose barbed fitting, with or without a tubing clamp. An inline filter may exist along the length of the tubing to remove contaminants moving to or from the instrument. Where a hose fluid line may be configured to carry an aspirate from the dental instrument, the hose fluid line may connect to one or more aspirator traps in order to collect aspirate and prevent liquids and/or solids from entering a pumping mechanism.

In one embodiment, the pumping module may have a temperature regulator in order to maintain a fluid at a set temperature and/or range of temperatures. The pumping module may also be able to select between different flow rates, pressures, fluids, and/or mixture ratios of fluids. In one embodiment, the pumping module may be able to detect and alert a user to a sudden increase in pressure, for instance, from a blocked aperture or a clogged fluid line. In another embodiment, the pumping module may comprise a feedback mechanism in order to deliver a fluid at a constant flow rate or at a constant pressure. In another embodiment, the pumping module may be able to transport a fluid in one direction, but then reverse and transport the fluid in the opposite direction. For instance, a particular aperture may be used for water irrigation, but then switched to aspiration when the pumping module reverses the direction of flow. The pumping module may have a console with controls and a screen to show set and actual parameters. In one embodiment, a foot pedal or foot switch may be electrically connected to and controlling the pumping module. This foot pedal may sit on the ground near the operator's foot, and be tethered to the pumping module by an electric wire. Alternatively, a foot pedal may extend from a bottom portion of the pumping module. Ideally, the dental instrument user may manipulate the foot pedal with his or her foot and without interrupting a procedure. The foot pedal may be any of those known in the medical instrument arts, or it may be a foot pedal similar to a piano, electric piano, sewing machine, power tool, automobile accelerator, or some other known foot pedal. The food pedal may be cylindrical with a diameter of 4-25 cm, preferably 6-20 cm, more preferably 7-14 cm and a height of 1-6 cm, preferably 1-4 cm, more preferably 1-3 cm. Alternatively, the foot pedal may be rectangular or some other shape with similar or different dimensions. The foot pedal may be a binary on/off switch for turning on or off a certain flow rate, or the foot pedal may allow intermediary positions that correspond to intermediary flow rates. Where the instrument handle comprises two or more handle fluid lines, the foot pedal may be split into two or more segments to control each handle fluid line, or there may be a separate foot pedal for each handle fluid line. Alternatively, the foot pedal may only regulate one handle fluid line at a time, which handle fluid line can be selected by a different control, such as a button, switch, or dial on the instrument handle or console.

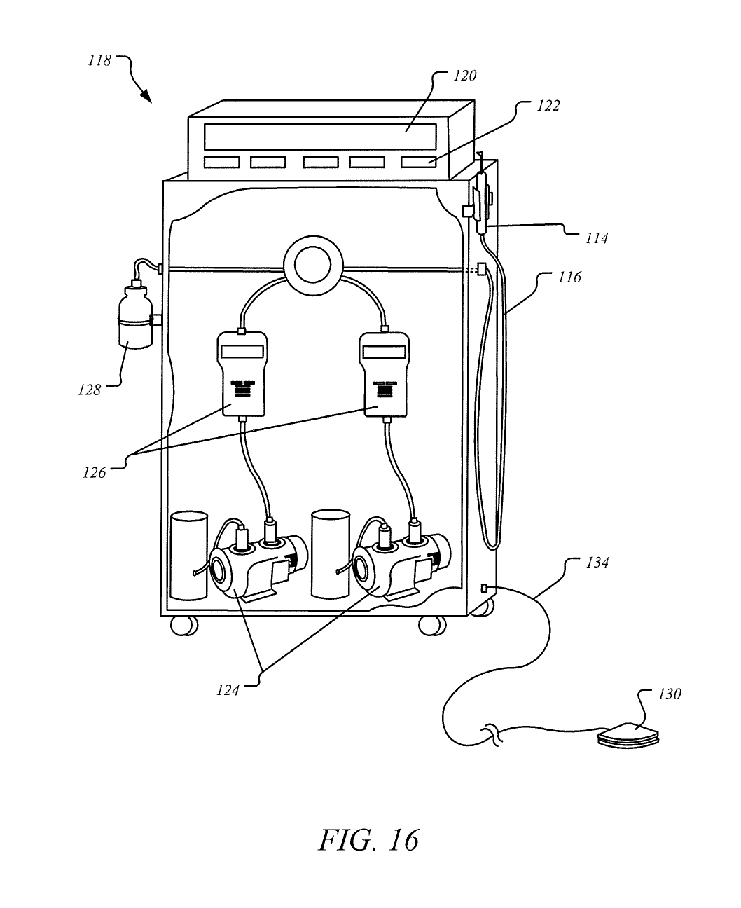

FIG. 16 shows an embodiment of a dental instrument assembly. The dental instrument 114 is connected by a hose 116 to an exterior of the pumping module 118. The pumping module has a console 120 with controls 122 for controlling the pumps 124 and temperature regulators 126. The pumping module has an aspirator trap 128 for use when a fluid line is aspirating, and the pumping module may be partly controlled by an electrically-connected foot pedal 130.

In one embodiment, the foot pedal may be electrically connected to and controlling a valve in the at least one first handle fluid line. This is shown in FIG. 17 where the dental instrument handle 10 has a first handle fluid line 12 with a valve 22 connected to an electric actuator 132. The wire 134 electrically connecting the actuator to the foot pedal 130 is attached to a portion of the hose. In an alternative embodiment, the wire may be threaded through the hose. In another alternative embodiment, the foot pedal may wirelessly control the pumping module and/or a valve on a handle fluid line. In another alternative embodiment, the foot pedal may not be electrically connected but connected by a pneumatic or hydraulic interface. The foot pedal, or an additional foot pedal, may also control an ultrasonic transducer or other electronics in the instrument handle or instrument head.

1: A dental instrument comprising:
an elongated handle with a hose end and a head end;
at least one first handle fluid line disposed in and traversing the handle from the hose end to the head end;
at least one second handle fluid line disposed in the handle and connected to the hose end,
an instrument head having a connection end and at least one first aperture at a distal end, wherein the connection end is removably attached to the head end of the handle; and
at least one first head fluid line disposed in and traversing the instrument head from the connection end to the at least one first aperture,
wherein the first handle fluid line is in fluid communication with the first head fluid line, and the instrument head comprises at least one selected from the group consisting of a blade, a spike, a spatula, a hook, a fork, and a bead.

2: The dental instrument of claim 1 wherein the instrument head comprises at least two first apertures in fluid communication with at least one first head fluid line.

3: The dental instrument of claim 1 wherein at least one first aperture is elongated.

4: The dental instrument of claim 1 wherein the connection end of the instrument head is removably attached to the head end of the handle by a screw thread connection.

5: The dental instrument of claim 1 further comprising an unthreaded joint assembly between the handle and the instrument head.

6: The dental instrument of claim 1 wherein the instrument head is a fork comprising a plurality of prongs, wherein the first aperture is disposed at the end of each prong and is in fluid communication with the at least one first head fluid line.

7: The dental instrument of claim 1 further comprising a slidable plunger within the at least one first handle fluid line.

8: The dental instrument of claim 1 wherein a plane enclosed by an edge of at least one first aperture is substantially perpendicular to an adjacent surface of the instrument head.

9: The dental instrument of claim 1 further comprising an ultrasonic transducer.

10: The dental instrument of claim 1 further comprising:
a joint in a middle portion of the first handle fluid line, wherein the second handle fluid line connects to and is in fluid communication with the first handle fluid line via the joint.

11: The dental instrument of claim 10 wherein the joint comprises a valve.

12: The dental instrument of claim 11 further comprising at least one button or at least one switch on an exterior surface of the handle to control the valve.

13: The dental instrument of claim 1 further comprising:
at least one second head fluid line disposed in and traversing the instrument head from the connection end to at least one second aperture at the distal end,
wherein the second handle fluid line traverses the handle from the hose end to the head end and is in fluid communication with the second head fluid line.

14: The dental instrument of claim 13 wherein a first plane enclosed by a first edge of the at least one first aperture is substantially parallel to a second plane enclosed by a second edge of the at least one second aperture, wherein the first and second apertures face each other.

15: The dental instrument of claim 13 wherein the first handle fluid line and the second handle fluid line are arranged coaxially.

16: The dental instrument of claim 13 wherein the instrument head is rotatably connected to the handle, wherein rotating the instrument head circumferentially relative to a longitudinal axis of the handle in a first position forms the fluid connection between the first handle fluid line and the first head fluid line and the fluid connection between the second handle fluid line and the second head fluid line, and rotating the instrument head circumferentially relative to the longitudinal axis of the handle in a second position disconnects the first handle fluid line from the first head fluid line and the second head fluid line from the second handle fluid line.

17: A dental instrument assembly comprising:
a dental instrument comprising:
an elongated handle with a hose end and a head end;
at least one first handle fluid line disposed in and traversing the handle from the hose end to the head end;
at least one second handle fluid line disposed in the handle and connected to the hose end,
an instrument head having a connection end and at least one first aperture at a distal end, wherein the connection end is removably attached to the head end of the handle; and
at least one first head fluid line disposed in and traversing the instrument head from the connection end to the at least one first aperture,
wherein the first handle fluid line is in fluid communication with the first head fluid line, and the instrument head comprises at least one selected from the group consisting of a blade, a spike, a spatula, a hook, a fork, and a bead; and
a pumping module fluidly connected to the hose end by a hose to deliver a fluid to the instrument head and carry an aspirate from the instrument head.

18: The dental instrument assembly of claim 17 wherein the pumping module comprises a temperature regulator.

19: The dental instrument assembly of claim 17 further comprising a foot pedal electrically connected to and controlling the pumping module.

20: The dental instrument assembly of claim 17 further comprising a foot pedal electrically connected to and controlling a valve in the at least one first handle fluid line.
